(19) United States
(12) Patent Application Publication
(10) Pub. No.: US 2010/0180599 A1
(43) Pub. Date: Jul. 22, 2010

(54) Insertable Pre-Drilled Swirl Vane for Premixing Fuel Nozzle

(76) Inventors: Stephen R. Thomas, Simpsonville, SC (US); Geoffrey D. Myers, Simpsonville, SC (US); Scott Simmons, Greenville, SC (US)

Correspondence Address: NIXON & VANDERHYE P.C., 901 NORTH GLEBE ROAD, 11TH FLOOR, ARLINGTON, VA, 22203, US

(21) Appl. No.: 12/356,572

(22) Filed: Jan. 21, 2009

(51) Int. Cl. F23R 3/14; B23P 11/00

(52) U.S. Cl. 60/737; 29/889.22

(57) ABSTRACT

A swirl vane is independently connectable to a central hub assembly of a gas turbine. The swirl vane includes a structural body and at least one fuel delivery passage including a corresponding at least one fuel port defined within the structural body. At least one connecting tab is cooperable with the structural body and is connectable to the central hub assembly.

### BACKGROUND OF THE INVENTION

The invention relates to a fuel nozzle in a gas turbine including a fuel/air premixer and, more particularly, to a fuel nozzle including independently insertable pre-drilled swirl vanes.

Typical industrial gas turbine premixing fuel nozzles may employ a cast swirl vane assembly in which a circular array of shaped hollow vanes are used to swirl the incoming air. The hollow vanes also serve as fuel delivery passages, where each vane is provided with several gas port holes drilled into the sides, through which fuel is injected into the passing air stream.

Gas turbine manufacturers are currently involved in research and engineering programs to produce new gas turbines that will operate at high efficiency without producing undesirable air polluting emissions. The primary air polluting emissions usually produced by gas turbines burning conventional hydrocarbon fuels are oxides of nitrogen, carbon monoxide, and unburned hydrocarbons. It is well known that oxidation of molecular nitrogen in air breathing engines is highly dependent upon the maximum hot gas temperature in the combustion system reaction zone. The rate of chemical reactions forming oxides of nitrogen (NOx) is an exponential function of temperature. If the temperature of the combustion chamber hot gas is controlled to a sufficiently low level, thermal NOx will not be produced. An existing method of controlling the temperature of the reaction zone of a heat engine combustor below the level at which thermal NOx is formed is to premix fuel and air to a lean mixture prior to combustion. The thermal mass of the excess air present in the reaction zone of a lean premixed combustor reduces the peak temperatures in the reaction zone to minimize formation of thermal NOx.

FIG. 1 illustrates a swozzle-type swirl vane assembly, which is described in U.S. Pat. No. 6,438,961. A premixing fuel nozzle is divided into four regions by function including an inlet flow conditioner, an air swirler assembly with natural gas fuel injection, an annular fuel air mixing passage, and a central diffusion flame natural gas fuel nozzle assembly. The function of the inlet flow conditioner is to prepare the air flow velocity distribution for entry into the premixer. After combustion air exits the inlet flow conditioner, it enters the swozzle assembly 2. The swozzle assembly includes a hub 201 and a shroud 202 connected by a series of air foil shaped turning vanes 23, which impart swirl to the combustion air passing through the premixer. Each turning vane 23 contains a primary natural gas fuel supply passage 21 and may also contain a secondary natural gas fuel supply passage 22 through the core of the air foil. These fuel passages distribute natural gas fuel to primary gas fuel injection holes and optionally to the secondary gas fuel injection holes that penetrate the wall of the air foil. The fuel injection holes may be located on the pressure side, the suction side or both sides of the turning vanes 23. Natural gas fuel enters the swozzle assembly 2 through inlet ports and annular passages that feed the primary and optionally the secondary turning vane passages, respectively. The natural gas fuel begins mixing with combustion air in the swozzle assembly 2, and fuel/air mixing is completed in the annular passage, which is formed by a swozzle hub extension and a swozzle shroud extension. After exiting the annular passage, the fuel/air. mixture enters the combustor reaction zone where combustion takes place.

There are numerous problems associated with the existing design. Flow testing is used to measure the effective opening area of the gas port orifices in the current configuration, and the flow testing is performed after these orifices have been drilled. If the gas port open area is too large, there is no process for repairing or modifying the part to correct this area, and an expensive part must thus be discarded. Additionally, current flow tests can assess the fuel circuit areas for the entire fuel nozzle, but cannot assess the vane-to-vane variation in fuel flow. Since NOx emissions are strongly influenced by local regions of high fuel-air ratio, it is desirable to provide as uniform a fuel-air mixture as possible.

Fuel nozzle gas port diameters are sized to accommodate a specific range of fuel compositions and temperatures. Changes in operating fuel temperature or fuel specific gravity can require a change in gas port orifice size to maintain proper operation of the gas turbine. As noted, however, such changes are not easily or. inexpensively effected. Current fuel nozzle designs employ uniform gas port diameters and locations in all swirl vanes. As combustion system analysis methods and system performance continue to evolve, benefits may be accrued from the use of varying gas port locations and/or diameters within a single fuel nozzle. With the prior design, it is not possible to vary the gas port locations and/or diameters without substantial nozzle reconstruction.

Flow field analysis has shown that the use of counter-rotating swirl in adjacent fuel nozzles can provide operational and/or performance benefits in the combustion system. The complexity of the prior fuel nozzle swirlers casting, however, requires expensive tooling, and thereby makes it very difficult to employ counter-rotating vane configurations.

Still further, prototype fuel nozzles in the prior design are costly and time-consuming to fabricate. In the prior design, the swirl vanes are integral to the swirl vane casting, which greatly limits the ability to modify prototype hardware for optimal fuel delivery and mixing.

It would be desirable to provide a design that addresses these drawbacks in the prior construction.

### BRIEF DESCRIPTION OF THE INVENTION

In an exemplary embodiment, a swirl vane is independently connectable to a central hub assembly of a gas turbine. The swirl vane includes a structural body, at least one fuel delivery passage including a corresponding at least one fuel port defined within the structural body, and at least one connecting tab cooperable with the structural body and connectable to the central hub assembly.

In another exemplary embodiment, a premixing fuel nozzle for a gas turbine includes a central hub assembly and a plurality of the independently connectable swirl vanes connected to the central hub assembly in a circular array.

In yet another exemplary embodiment, a method of assembling a premixing fuel nozzle for a gas turbine includes the steps of (a) preparing a plurality of swirl vanes to each include a structural body, at least one fuel delivery passage including a corresponding at least one fuel port defined within the structural body, and at least one connecting tab cooperable with the structural body; and (b) securing the plurality of swirl vanes independently to a central hub assembly of the premixing fuel nozzle.

### BRIEF DESCRIPTION OF THE DRAWINGS

FIG. 1 shows a prior art swozzle-type swirl vane assembly;

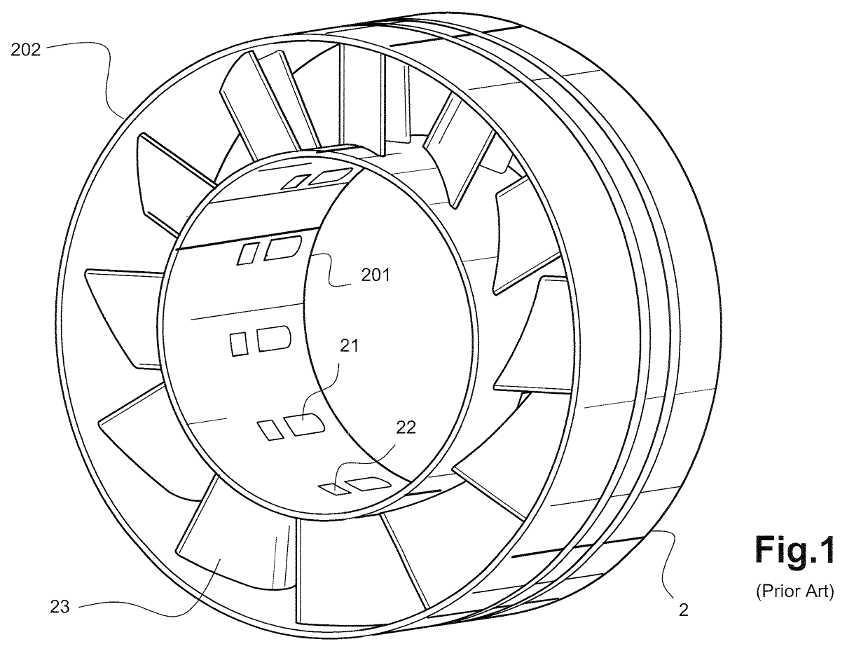

FIG. 2 is a perspective view of an independently insertable pre-drilled swirl vane; and

FIG. 3 is a side and top view of an independently insertable pre-drilled swirl vane and mating swirl hub assembly, and a section view of the swirler hub assembly.

### DETAILED DESCRIPTION OF THE INVENTION

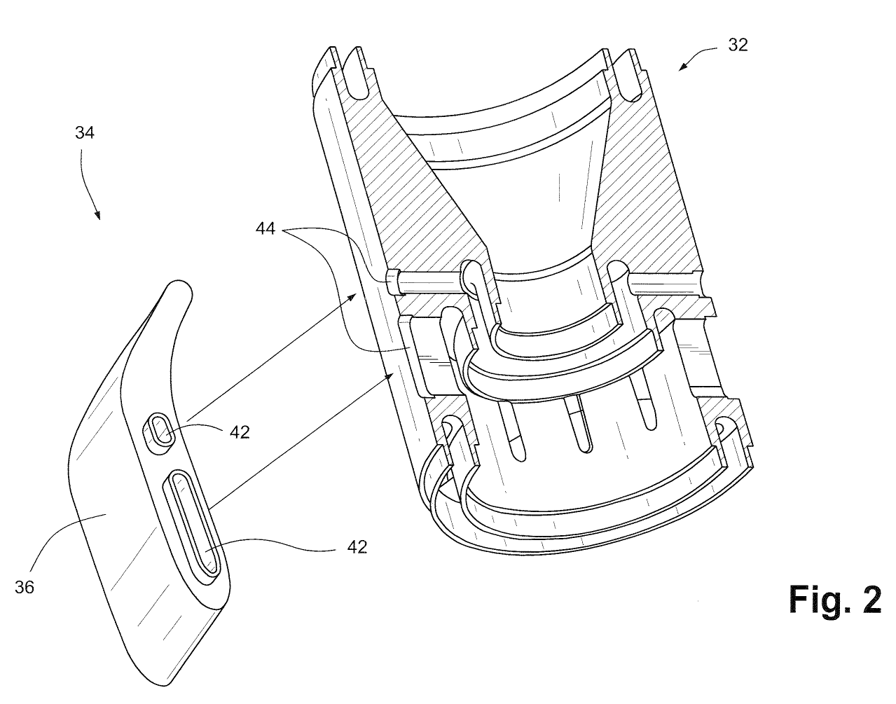

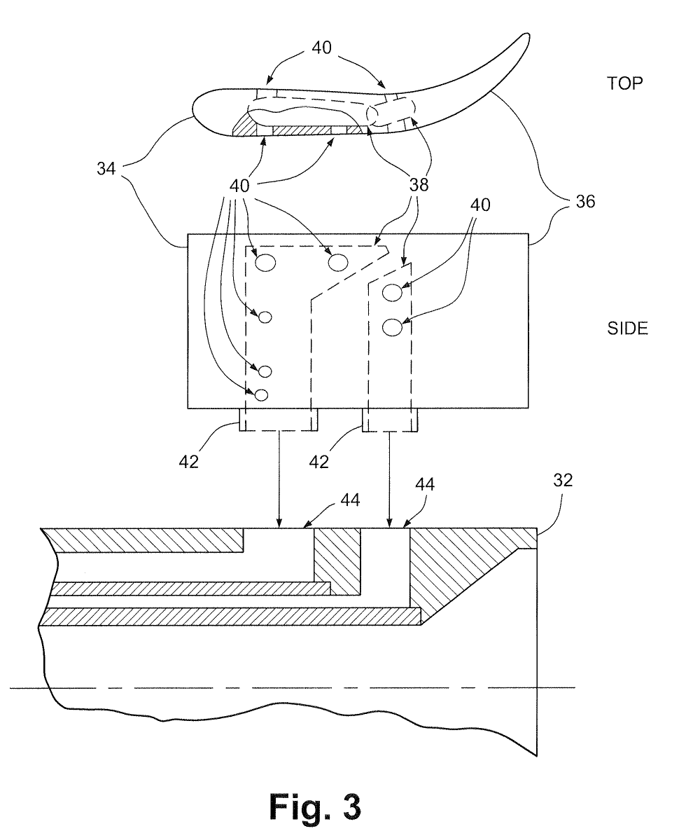

FIGS. 2 and 3 depict a partial assembly drawing showing a central hub assembly 32 of a gas turbine and an independently connectable swirl vane 34. Although only a single exemplary vane is shown, it is representative of a plurality of vanes. The exemplary swirl vane 34 includes a generally hollow structural body 36 including at least one fuel delivery passage 38 and a corresponding at least one fuel port 40 defined within the structural body 36. The gas ports 40 can be circular or non-circular and can be formed using drilling, electrical discharge machining (EDM), or any other known process. The gas ports can be formed on either the suction or pressure side of the vane, or both sides, and may be normal or canted relative to the surface of the vane.

Preferably, the structural body 36 includes a plurality of fuel delivery passages 38 and corresponding fuel ports 40. At least one connecting tab 42 is cooperable with the structural body 36 and is connectable to corresponding slots 44 in the central hub assembly 32.

The independently connectable swirl vane 34 has its fuel passages and ports 38, 40 drilled or machined prior to installation into the central hub assembly 32. By pre-forming fuel passages and ports 38, 40 prior to installation, each swirl vane 34 can be flow-tested individually to ensure that the fuel circuit effective flow area meets design intent. That is, flow-testing can be used to tune the individual vanes 34 for assurance of proper flow characteristics. The independently connectable swirl vanes 34 are then inserted into the central hub assembly 32 and brazed, swaged, welded or connected using any other known process into position via connecting tabs 42 and corresponding slots 44. With individually flow-tested vanes 34, the completed vane assembly would necessarily automatically meet design intent.

Because vanes 34 are individually flow-tested, rather than testing the entire assembly as a unit, vane-to-vane variation can be directly measured and easier to control. Moreover, insertable swirl vanes 34 provide a relatively easy way to re-size fuel nozzles for changes in fuel composition. In an exemplary application, the vanes 34 can be machined off the central hub assembly 32 and replaced with re-sized swirl vanes, rather than replacing an entire fuel nozzle.

The vanes 34 can be cast or machined in both a clockwise and counterclockwise rotational orientation to permit the easy use of counter-rotating swirl. Casting tooling for an individual vane is much less expensive and requires less manufacturing time. Still further, the insertable swirl vanes 34 facilitate the testing of alternate concepts since the vanes can be made more quickly and at a lower cost.

A clocking feature can be incorporated into the fuel nozzle base, so that the fuel nozzle can only be installed in one orientation relative to the combustor liner; this feature would insure that the position of each swirl vane was fixed, relative to the combustion flow field inside the liner. By incorporating a clocking feature on the base of the fuel nozzle (so that its orientation relative to the combustion liner is known), it is possible to use swirl vanes of varying orifice diameters and/or locations to deliver an improved fuel-air distribution into the combustor. Improved access to the gas port locations on an individual vane makes it easier and less expensive to vary gas port orientations among the vanes.

In the illustrated embodiment, the swirler assembly shroud may be a separate entity rather than an integral part of the swirler assembly.

The insertable swirl vanes 34 can serve to deliver fuel in a non-symmetric, preferentially-oriented manner by incorporating features in the fuel nozzle design that position the fuel nozzle in a unique orientation with respect to the combustor. Analysis of the combustor internal flow field may indicate fuel-rich or fuel-lean regions that can be made more uniform by fitting swirl vanes with larger or smaller ports in some sections of the premixing assembly. Because the flow areas of each swirl vane are known prior to assembly, the fuel-air distribution inside the premixing assembly can be tuned to deliver a richer or leaner mixture into different regions of the combustor.

With the independently connectable swirl vanes, fuel nozzle manufacturing time and prototype hardware procurement time can be reduced. Moreover, the independent vanes provide for greater design flexibility. Gas port holes can be drilled into individual vanes much more easily than in a single vane casting since access to the side of the vanes is unimpeded. Moreover, since tooling for drilling the holes is much less complex, there is greater flexibility to use varying gas port configurations among the different vanes in the assembly. This variation offers potential advantages in combustion system operability and emissions, which could yield gas turbine performance improvements.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A swirl vane independently connectable to a central hub assembly of a gas turbine, the swirl vane comprising:
a structural body;
at least one fuel delivery passage including a corresponding at least one fuel port defined within the structural body; and
at least one connecting tab cooperable with the structural body and connectable to the central hub assembly.

2. A swirl vane according to claim 1, comprising a plurality of fuel delivery passages and a corresponding plurality of fuel ports.

3. A swirl vane according to claim 1, wherein the structural body is cast or machined in a clockwise rotational orientation.

4. A swirl vane according to claim 1, wherein the structural body is cast or machined in a counter-clockwise rotational orientation.

5. A swirl vane according to claim 1, wherein the swirl vane is flow-tested prior to connecting to the central hub assembly.

6. A premixing fuel nozzle for a gas turbine, the fuel nozzle comprising:
a central hub assembly
a plurality of independently connectable swirl vanes connected to the central hub assembly in a circular array, each of the plurality of swirl vanes including:
a structural body, N
at least one fuel delivery passage including a corresponding at least one fuel port defined within the structural body, and
at least one connecting tab cooperable with the structural body and connectable to the central hub assembly.

7. A premixing fuel nozzle according to claim 6, wherein each of the plurality of swirl vanes is individually flow-tested prior to assembly of the premixing fuel nozzle.

8. A premixing fuel nozzle according to claim 6, wherein each of the plurality of swirl vanes is independently replaceable.

9. A method of assembling a premixing fuel nozzle for a gas turbine, the method comprising:
(a) preparing a plurality of swirl vanes to each include a structural body, at least one fuel delivery passage including a corresponding at least one fuel port defined within the structural body, and at least one connecting tab cooperable with the structural body; and
(b) securing the plurality of swirl vanes independently to a central hub assembly of the premixing fuel nozzle.

10. A method according to claim 9, wherein step (a) is practiced by drilling or machining the at least one fuel port in the structural body prior to step (b).

11. A method according to claim 9, wherein step (a) is practiced by individually flow-testing each of the plurality of swirl vanes prior to step (b) to ensure that a fuel circuit effective flow area meets predefined criteria.

12. A method according to claim 9, further comprising resizing the premixing fuel nozzle by replacing the plurality of swirl vanes with a plurality of differently-sized swirl vanes.

13. A method according to claim 9, wherein step (a) is practiced by individually casting or machining the plurality of swirl vanes in both a clockwise and a counter-clockwise orientation.

14. A method according to claim 9, wherein step (a) is practiced by individually tuning each of the plurality of swirl vanes according to predefined flow characteristics.

15. A method according to claim 9, wherein step (b) is practiced by brazing, swaging or welding the connecting tab of each of the plurality of swirl vanes to the central hub assembly.
